(19) United States
(12) Patent Application Publication
(10) Pub. No.: US 2008/0259596 A1
(43) Pub. Date: Oct. 23, 2008

(54) Color Adaptive Lighting System

(75) Inventors: Alois Biebl, St. Johann (DE); Jens Clark, Ebersberg (DE); Ulrich Henger, Eichenau (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MBH, Munchen (DE)

(21) Appl. No.: 11/884,703

(22) PCT Filed: Feb. 15, 2006
(86) PCT No.: PCT/DE2006/000275

§ 371 Date: Aug. 20, 2007

(30) Foreign Application Priority Data
Feb. 18, 2005 (DE) 10 2005 007 565.7

(51) Int. Cl. F21S 2/00

(52) U.S. Cl. 362/228

(57) ABSTRACT

A color adaptive lighting system for creating a mixture of light that lies on the Planck's radiation course, includes: a housing (2; 17; 27); a first light source in the form of at least one low-pressure gas discharge lamp; a second light source in the form of at least two light-emitting diodes (LED's) (9, 10; 21, 22; 33, 34); at least one reflector (3; 17; 27) that is placed behind the low-pressure gas discharge lamp (4; 18, 28) in the direction of emission of the lighting system; optionally a diffusing disc and/or cover disc (13, 14; 19, 20), and; a ballast for operating the light sources and for controlling the intensity of the light sources. The at least two LED's (9, 10; 21, 22; 33, 34) are arranged in the lighting system in such a manner that the main direction of emission of the LED's (9, 10; 21, 22; 33, 34) points toward the reflector.

### TECHNICAL FIELD

The invention relates to a color-adaptive lighting system for producing a light mixture which lies on the Planckian locus, having a housing, a first light source in the form of at least one low-pressure discharge lamp, a second light source in the form of at least two light-emitting diodes (LEDs), at least one reflector, which is arranged downstream of the low-pressure discharge lamp in the emission direction of the lighting apparatus, and a ballast for operating the light sources and controlling the intensity of the light sources.

### PRIOR ART

WO 2004/011846 A1 has disclosed a lamp system in which a fluorescent lamp with a color locus in the green-blue spectral range is combined with an LED with a color locus in the yellow-red spectral range. This lamp system requires the use of fluorescent lamps with a special fluorescent coating and excludes the use of “normal” fluorescent lamps with a white color locus. In addition, no “normal” red, green and blue LEDs can be used either, but LEDs with a special yellow-red spectral range are required for this lamp system.

### DESCRIPTION OF THE INVENTION

The object of the present invention is to provide a color-adaptive lighting system comprising red, green and blue LEDs and a conventional “white” fluorescent lamp, with which a light mixture can be produced which lies on the Planckian locus. The aim is to provide a lighting apparatus which produces an individually adjustable white light for lighting purposes. In this case, the light mixture should be so homogeneous that, even at the diffusing and/or covering plate, which emits the light, of the lighting system, no differently colored points or areas are visible. At the same time, the heating-up of the LEDs should be kept as low as possible in order to achieve an efficiency of the lighting system and of the life of the LEDs which is as high as possible.

In the case of a color-adaptive lighting system having a housing, a first light source in the form of at least one low-pressure discharge lamp, a second light source in the form of at least two light-emitting diodes LEDs, at least one reflector, which is arranged downstream of the low-pressure discharge lamp in the emission direction of the lighting apparatus, and a ballast for operating the light sources and controlling the intensity of the light sources, the object is achieved by virtue of the fact that the at least two LEDs are arranged in the lighting system in such a way that the main emission direction of the LEDs points in the direction of the reflector.

Owing to the fact that the light from the LEDs is emitted into the reflector, the path of the light is extended until it emerges from the lighting system and thorough mixing of the light from the low-pressure discharge lamp with the light from the LEDs is markedly improved. Owing to the alignment of the differently colored LEDs in the direction of the rearward reflector, the LEDs are no longer visible behind a possible diffusing and/or covering plate. Advantageously, the low-pressure discharge lamp is a compact fluorescent lamp or a linear fluorescent lamp.

For an optimum light mixture, the lighting system, as the second light source, advantageously comprises more than two LEDs, the LEDs having a yellow, red, green and/or blue light spectrum. LEDs with differently colored light spectra can also be combined to form one LED in a common housing. As a result, the control of the light color of the light produced by the lighting system is improved.

Optimum operation and long life of the LEDs requires an ambient temperature for the LEDs which is as cool as possible. For this purpose, the LEDs are fixed on a holder, which consists of a heat-dissipating material. In addition, the holder may have cooling ribs in order to achieve further improved cooling.

In order to construct the lighting system in a manner which is as simple and cost-effective as possible, it is also conceivable for the housing of the lighting apparatus itself to consist of a thermally conductive material (metal) and for the LEDs to be fixed directly to the housing. In this case, the cooling ribs are advantageously fitted on the outside on the housing.

The light mixture of the light from the low-pressure discharge lamp with the light from the LEDs is further improved if, in the case of a plurality of LEDs, these LEDs are each arranged in a row parallel to the axis of the first light source to the left and to the right of the first light source. In this case, it is expedient for avoiding streaking for the LEDs which are arranged in a row to each alternate in terms of their light color. If, on the other hand, LEDs are used in which the light mixture already takes place in the LED housing, such as, for example, so-called red-green-blue LEDs (RGB LEDs) in which each RGB LED comprises a red, green and blue LED, the sequence no longer needs to be followed since in this case the light color of the RGB LEDs can take place by means of them being driven.

The lighting system advantageously has a covering plate in the emission direction and possibly a diffusing plate which is positioned upstream of the covering plate in the emission direction, it also being possible for the covering plate and the diffusing plate to be combined to form a common covering and diffusing plate.

### BRIEF DESCRIPTION OF THE DRAWINGS

The invention will be explained in more detail below with reference to exemplary embodiments. In the figures:

FIG. 1 shows the positions of the individual light sources of a lighting system in the standard chromaticity diagram,

FIG. 2 shows a section through a first embodiment of a lighting system,

FIG. 3 shows, schematically from below, the construction of the lighting system shown in FIG. 1,

FIG. 4 shows a section through a second embodiment of a lighting system according to the invention, and

FIG. 5 shows a section through a third embodiment of a lighting system according to the invention.

### PREFERRED EMBODIMENTS OF THE INVENTION

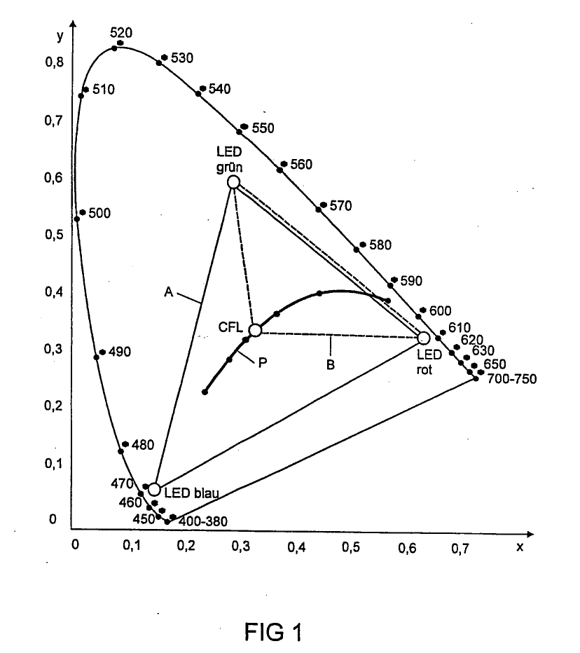

FIG. 1 illustrates the position of the individual light sources of a lighting system according to the invention. In this case, the lighting system has a white compact fluorescent lamp CFL and at least in each case one blue, green and red LED. With a lighting system which contains all four light sources, light can be realized with all color loci within the triangle A formed by the three differently colored LEDs, and naturally in particular all color loci on the Planckian locus. If the lighting system has, in addition to the white compact fluorescent lamp CFL, only red and green LEDs, all color loci of the smaller triangle B indicated by dashed lines can be represented by the lighting system, in particular in this case all color loci on the Planckian locus to the right of the color locus of the compact fluorescent lamp CFL.

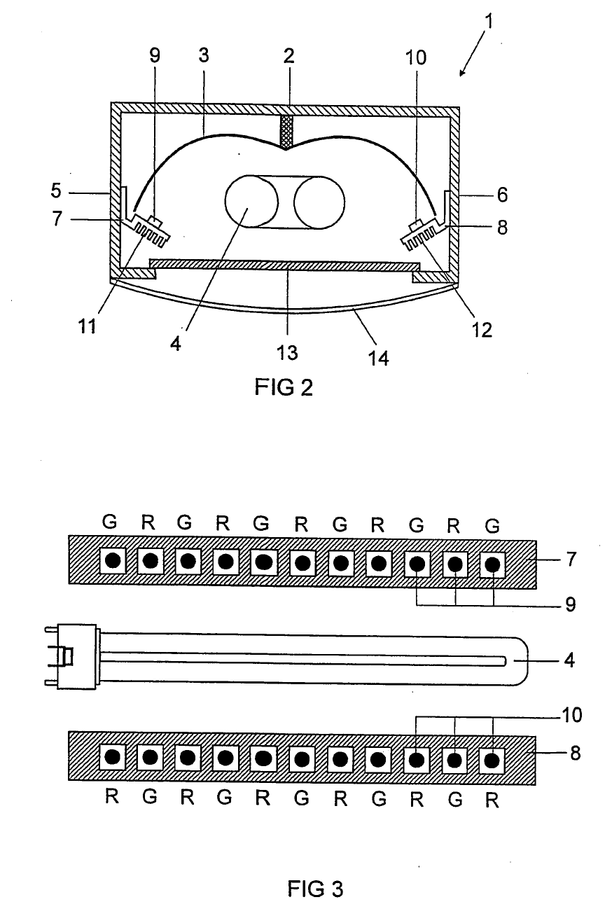

FIG. 2 shows a section through a first embodiment of a lighting system according to the invention. The lighting system has the shape of a luminaire 1. The luminaire 1 has a rectangular housing 2, to whose top face a curved reflector 3 is fitted on the inside. A compact fluorescent lamp 4 with a discharge vessel which has been bent once (see FIG. 2) is fitted parallel to the axis of symmetry of the reflector 3 in front of the reflector 3.

Furthermore, holders 7, 8 consisting of a highly conductive material such as, for example, aluminum are also fixed on the inside to the two longitudinal sides 5, 6 of the housing 2, on which holders LEDs 9, 10 are applied in thermally conductive contact. The holders 7, 8 are in this case designed such that the LEDs are positioned in front of the edge of the reflector 3 and their axis of symmetry is directed towards the inner face of the reflector 3 in such a way that virtually all of the light produced by the LEDs 7, 8 is emitted into the reflector 3. For improved dissipation of heat, the holders also have cooling ribs 11, 12.

For increased light mixing, the light exit opening of the housing is covered by a diffusing plate 13. The luminaire also has a translucent cover 14 in front of the diffusing plate.

FIG. 2 illustrates schematically the construction of the luminaire, when viewed from below. The LEDs 9, 10 are arranged on the holders 7, 8 on both sides of the lamp, parallel to the elongated discharge vessel of the compact fluorescent lamp 4 which has been bent once. With this luminaire, in each case eleven red (R) and green (G) LEDs are fitted with an alternating sequence onto the holders 7, 8, in each case one red and one green LED being opposite one another with respect to the compact fluorescent lamp.

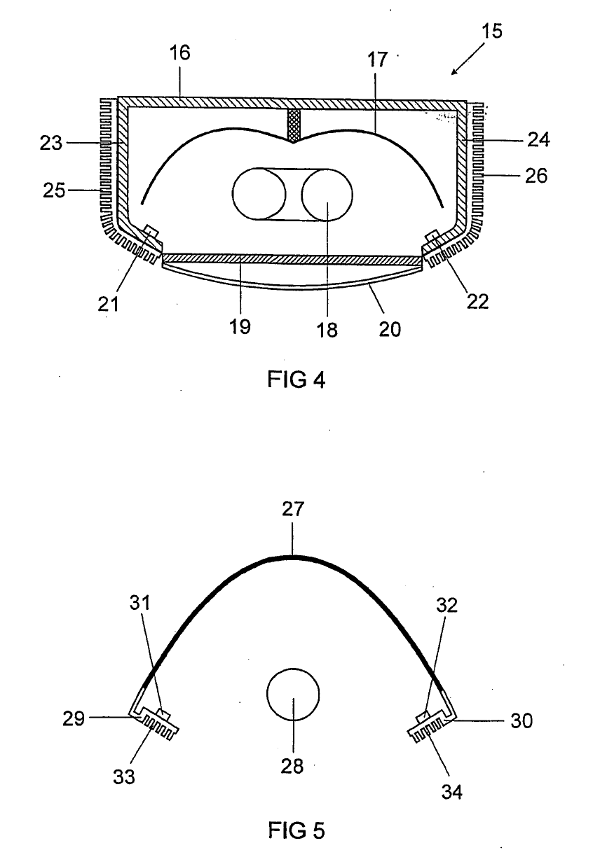

FIG. 4 shows a section through a second embodiment of a lighting system according to the invention, again in the form of a luminaire 15. The luminaire 15 likewise has a rectangular housing 16, a symmetrical reflector 17, a compact fluorescent lamp 18, a diffusing plate 19 and a covering plate 20. The LEDs 21, 22 are in this case not mounted on additionally fitted holders, however, but are fitted directly onto the inner sides of the side walls 23, 24 of the highly thermally conductive housing 16. In order that the LEDs 21, 22 emit as high a percentage as possible of the light produced by them into the reflector, the side walls are bent inwards towards the emission opening in their lower section. In addition, the side walls are provided with cooling ribs 25, 26 for increased heat dissipation.

FIG. 5 shows, in section, a further simplified construction of a luminaire, in which the trough-shaped reflector 27 at the same time forms the housing of the luminaire. The luminaire has a linear fluorescent lamp 28, which runs in the axis of symmetry of the reflector 27. Fitted at the lateral ends of the reflector 27 are holders 29, 30, which bear the LEDs 31, 32 and are equipped with cooling ribs 33, 34 for heat dissipation.

All the light sources are operated via a ballast (not illustrated here), which is likewise included in the lighting systems in FIGS. 2 to 5. In this case, the intensity of the individual light sources for adjusting a specific color temperature of the light emitted by the lighting system is also controlled by the ballast.

1. A color-adaptive lighting system for producing a light mixture which lies on the Planckian locus, having a housing (2; 17; 27), a first light source in the form of at least one low-pressure discharge lamp, a second light source in the form of at least two light-emitting diodes (LEDs) (9, 10; 21, 22; 33, 34), at least one reflector (3; 17; 27), which is arranged downstream of the low-pressure discharge lamp (4; 18; 28) in the emission direction of the lighting system, and a ballast for operating the light sources and controlling the intensity of the light sources, characterized in that the at least two LEDs (9, 10; 21, 22; 33, 34) are arranged in the lighting system in such a way that the main emission direction of the LEDs (9, 10; 21, 22; 33, 34) points in the direction of the reflector.

2. The lighting system as claimed in claim 1, characterized in that the low-pressure discharge lamp is a compact fluorescent lamp (4; 18).

3. The lighting system as claimed in claim 1, characterized in that the low-pressure discharge lamp is a linear fluorescent lamp (28).

4. The lighting system as claimed in claim 1, characterized in that the second light source comprises more than two LEDs (9, 10; 21, 22; 33, 34).

5. The lighting system as claimed in claim 4, characterized in that the LEDs (9, 10; 21, 22; 33, 34) have a yellow, red, green and/or blue light spectrum.

6. The lighting system as claimed in claim 5, characterized in that in each case a plurality of LEDs with differently colored light spectra are combined to form one LED in a common housing.

7. The lighting system as claimed in claim 1, characterized in that the LEDs (9, 10; 21, 22; 33, 34) are fixed on holders (7, 8; 29, 30), which consist of a heat-dissipating material.

8. The lighting system as claimed in claim 1, characterized in that the holders (7, 8; 29, 30) have cooling ribs (11, 12; 33, 34).

9. The lighting system as claimed in claim 1, characterized in that the housing (2; 17; 27) of the lighting apparatus consists of a thermally conductive material.

10. The lighting system as claimed in claim 9, characterized in that the LEDs are fixed directly to the housing (2; 17; 27).

11. The lighting system as claimed in claim and 10, characterized in that cooling ribs (25, 26) are fitted on the outside on the housing (2; 17; 27).

12. The lighting system as claimed in claim 4, characterized in that the LEDs (9, 10; 21, 22; 33, 34) are arranged in, in each case, a row parallel to the axis of the first light source to the left and to the right of the first light source.

13. The lighting system as claimed in claim 12, characterized in that, when using LEDs (9, 10; 21, 22; 33, 34) with different light colors, the LEDs arranged in a row each have an alternating light color.

14. The lighting system as claimed in claim 1, characterized in that the lighting system has a covering plate (14; 20) in the emission direction and possibly a diffusing plate (13; 19) which is positioned upstream of the covering plate (14; 20) in the emission direction, it also being possible for the covering plate and the diffusing plate to be combined to form a common covering and diffusing plate.
